(19) United States
(12) Patent Application Publication
(10) Pub. No.: US 2011/0086194 A1
(43) Pub. Date: Apr. 14, 2011

(54) Security inherent wrap label with patterned adhesive

(76) Inventor: Robert E. Williams, Collinsville, IL (US)

(21) Appl. No.: 12/928,363

(22) Filed: Dec. 9, 2010

Related U.S. Application Data
(63) Continuation-in-part of application No. 12/924,728, filed on Oct. 4, 2010.
(60) Provisional application No. 61/278,383, filed on Oct. 6, 2009.

(51) Int. Cl. G09F 3/03; G09F 3/10

(52) U.S. Cl. 428/43

(57) ABSTRACT

A patterned adhesive tag applied to separable-lid containers, hinged-lid containers, film-lid containers, and other packaged products. The patterned tag adhesive is designed to add security to the packaging of the goods, such that when an unauthorized person tries to remove the tag, it will tear, indicating an unauthorized entry, and caution against purchase or usage of the product. The tag is designed to wrap around a plurality of sides of the packaged product. The tag may be multi-layered through the usage of additional adhesives and substrates to facilitate couponing and booklet applications for the marketed product.

### CROSS REFERENCE TO RELATED APPLICATION

This continuation-in-part patent application claims priority to the non-provisional patent application having Ser. No. 12/924,728, having filing date of Oct. 4, 2010, which claims priority to the provisional patent application having Ser. No. 61/278,383, having filing date of Oct. 6, 2009.

### BACKGROUND OF THE INVENTION

This invention relates generally to an adhesive backed label or tag that is affixed to a product to provide security and tamper evidence, in addition to product identification, couponing, advertisement, bar coding, or any other marketing information that desirably is applied to the package. This invention further relates to a label or tag with patterned adhesive backing that can be affixed to a package or product to obtain the type of uses as described, or which may have any other information that may be applied to the package. Adhesive labels in an enormous variety of shapes and sizes that are attached to packages to carry printed information about contents, safety, manufacturer, and any number of other subjects. One of the severest limitations of the utility of an adhesive label is the area of the label available for printing. A simple label with adhesive covering the majority of its bottom face has only the primary surface of the top face for printing the desired information.

Various means have been proposed to increase the label area available for printing. A common solution taught, for example, in Pat. No. 6,073,377, to Mehta, and in Pat. No. 4,727,667, to Ingle, employs what may be called an extended wrap label. Such a label has a length greater than the circumference of the container and wraps over itself, using a releasable adhesive to attach the upper layer or layers to the structure affixed to the container.

Another means of increasing the label area available for printing is taught, for example, in Pat. No. 7,306,263, to Hudson. The Hudson patent teaches a label with a plurality of contiguous fan-folded pages affixed by adhesive to the surface of the label, with strips of adhesive on the edges of the pages to hold them flat when not in use.

These inventions teach labels with adhesive substantially covering their bottom surfaces. The information-carrying potential of the bottom surfaces of these labels is therefore wasted. In addition, the width of these labels is uniform throughout, requiring the inclusion of non-used material.

### SUMMARY OF THE INVENTION

The present invention provides a label with patterned adhesive that adds to the security of the packaged goods, and allows for more efficient use of the primary surface of the label using less material. The label is designed to wrap around three or four sides of the container or package, with adhesive applied only to the ends of the label so that the label is primarily adhered to the sides or bottom of the container while leaving non-adhesive, unattached portions available on the primary surface of the label for back printing, couponing, bar coding, or any other purpose.

The tag can be a variety of shapes and sizes with the function and patterning of the adhesive and security features creating the distinctive application of the tag. The tag is designed for security and tamper evidence, product identification, coupons, safety verbiage, manufacturers rebates, cross-branding, receipts, and promotional advertising. The adhesive area of the tag is patterned so that the tag is primarily adhered to the sides or secondary surfaces of the container or product while leaving the patterned adhesive or non-adhesive, unattached portions available on the backside of the primary surface of the tag for a variety of purposes including, but not limited to, repositionability, back printing, couponing, security features, and the like. The backside of the primary surface may have additional adhesive coverage designed to assist in applying the label with automatic labeling equipment. In addition, the tag will incorporate a series of security die-cuts on the portion of the tag that adheres to the sides or secondary surfaces of the product being labeled. Said die-cuts serve as a destructible agent so that any attempts to remove the tag from the product will cause it to tear or destruct at the point of attachment giving evidence that the product has been tamper with.

In the preferred embodiment, a label is designed for a six-sided container. The label is a planar section of material with a front, a back, two ends, a primary surface roughly midway between the two ends, and two legs, narrower than the primary surface, extending between the primary surface and the ends. The primary surface is of a greater width than the remainder of the label. An adhesive is applied to tabs at each end of the label. The label may be constructed of a variety of films in a variety of calipers, including, but not limited to, high density polyethylene (HDPE), polypropylene, vinyl, polyester, polystyrene, and synthetic papers. The label may also be constructed of a variety of calipers and types of traditional papers, including, but not limited to, electronic data processing (EDP), bond, offset, tag, index, ledger, direct thermal, thermal transfer, high-gloss, semi-gloss, and linen papers. In the preferred embodiment, the adhesive is a pressure-sensitive adhesive, but a variety of adhesives may be used, including, but not limited to, permanent and removable adhesives; emulsion acrylic adhesives; hot melt rubber base adhesives; and UV curable adhesives. The primary surface of the label may be printed on either or both sides for use as a coupon, warning label, description of contents, bar code, promotion, incentive, or any other use desired. The primary surface of the label is placed on the top of the package or container, and the legs of the label wrap around the sides and/or bottom of the container, where the ends are affixed thereto by the adhesive on the end tabs. The primary surface of the label thus remains unaffixed to the container. The label may also be shaped so that the legs can be threaded through part of the container itself prior to attachment of the label ends.

With regard to the application of adhesives, the adhesive utilized is equally versatile and includes, but is not limited to, permanent and removable adhesives, emulsion acrylic adhesives, hot melt rubber based adhesives, UV curable adhesives, and the like. The adhesive patterning can be accomplished by chemically deadening portions of the adhesive on commercially available pressure sensitive materials or by patterning the adhesive during the adhesive coating process which leaves portions of the tag without an adhering adhesive.

The tag may or may not be perforated depending on the purpose and the end use of the tag. These perforations can be designed for tear-off coupons, peel and reveal applications, position to aid in opening the container or package, and the like. The tag may or may not be printed on the front and back. The tag may be multi-layered using various materials and adhesives for instant redeemable coupons or to provide additional space for advertising, instructions, receipts, and the like.

In another embodiment, adhesive may also be applied to the back of the primary surface of the label to facilitate application with automatic labeling equipment.

In another embodiment, a booklet or similar means of expansion may be affixed by reusable adhesive to either side of the primary surface of the label to provide greater capacity for printed information.

In another embodiment, perforation or die-cuts may be added to the label to allow for detachment of the primary surface from the remainder of the label.

A further concept of this invention is to provide a label that is tamper proof, and should the label be torn, or partially removed, it would be indicative of an unauthorized entry into the container, to caution a potential purchaser against acquisition.

The principal object of this invention is to provide a patterned adhesive, destructible tag, that is attached to the sides or bottom of the container or packaged product while incorporating various adhesive patterns on the backside of the primary panel of the tag leaving a portion unattached for back printing and couponing, etc., or with a patterned adhesive to make the tag repositionable as an aid in hand application of the tag. The design of the tag lends itself to various sustainability initiatives including, but not limited to, recycling, package material reduction leading to less landfill waste, and the use of biodegradable materials. Obviously, the specific shape of the tag is variable, depending upon the nature of the labeling, the couponing, or what is required for the particular security tag when applied to the packaged container employed.

Another primary purpose of this invention is to provide a security inherent wrap label with a patterned adhesive that allows for the label to tear, in the event that one tampers with it in an effort to attain unauthorized entry into the packaged goods.

Other objects and purposes of this invention may occur to those skilled in the art upon review of the invention as provided herein. Such variations, if within the sprit of the invention, are intended to be inclusive of the patentable aspects of this development.

### BRIEF DESCRIPTION OF THE DRAWINGS

In referring to the drawings:

FIG. 1 shows a bottom plan view of a wrap label with a relatively larger primary surface, two relatively narrow legs, and two adhesive ends;

FIG. 2 shows a wrap label in use upon a hinged-lid container, noting that the primary surface of the tag substantially covers the top of the container;

FIG. 3 shows a similar view to that of FIG. 2, but with the shown adhesive end of the label having been torn, to indicate that unauthorized entry has been attempted;

FIG. 4 provides a plan view of a modification to the wrap label, showing its pattered adhesive and security die-cut lines that prevents unauthorized removal of the label from its container; and

FIG. 5 shows a wrap label similar to that of FIG. 4, but showing where a coating has been applied to achieve adhesive deadness for the label so it does not adhere at that location, during usage.

### DETAILED DESCRIPTION OF THE INVENTION

With reference to the drawings:

FIG. 1 is a bottom plan view of the preferred embodiment of a wrap label 10 with primary surface 11, legs 12, and ends 13. Slanted lines represent tear lines at the ends 13 of the label. Broken lines represent the location of the adhesive surfaces as at 15. The markings provided at 15 show the limit of application of adhesive to the ends 13 of the label, so that the label is held to position by the adhesive provided at these two end locations, leaving the rest of the label free for couponing, labeling, or for other indicia, that may be peeled or torn free to be used for further instructions when the contained product is used.

The die-cut lines 16 are what enhance the security aspects of the label, so that if one attempts to peel one end of the label free, by tearing along its end 13, when the peeling reaches the location of the die-cut lines 16, the ends will tear, showing that the packaged product, and its labeling, has been tampered with, and that it should be reported, and not purchased or used. Obviously, this pattern of die-cuts can be to any configuration or shape, and not as that as shown, since any pattern of die-cut lines that provides for a tearing of the label ends, when unauthorized tampering occurs, will suffice for security purposes.

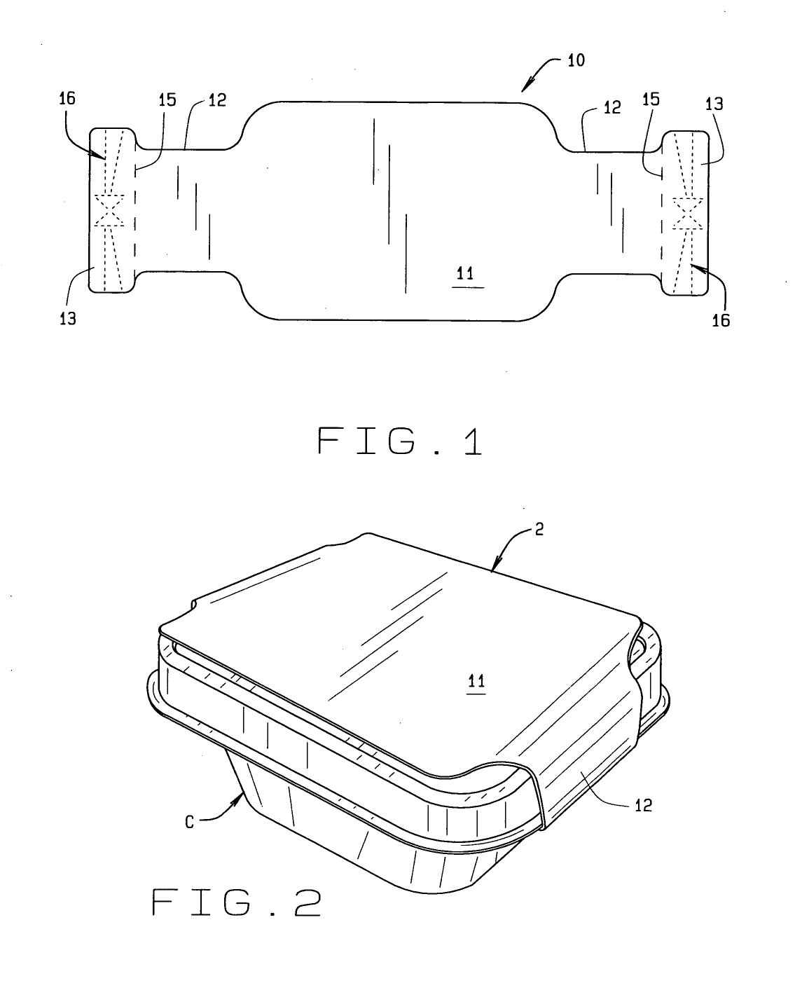

FIG. 2 is a perspective view of a wrap 10 label in use on a substantially six-sided hinged-lid container. The label has been formed so that its primary surface 11 substantially covers the top of the container, and the edges of the primary surface are substantially contiguous with the contoured edges of the container to make maximum use of the information-carrying capacity of the label's primary surface. As can be seen and understood, the bottom face of the primary surface is not adhered to the container. The legs 12 of the label, as in

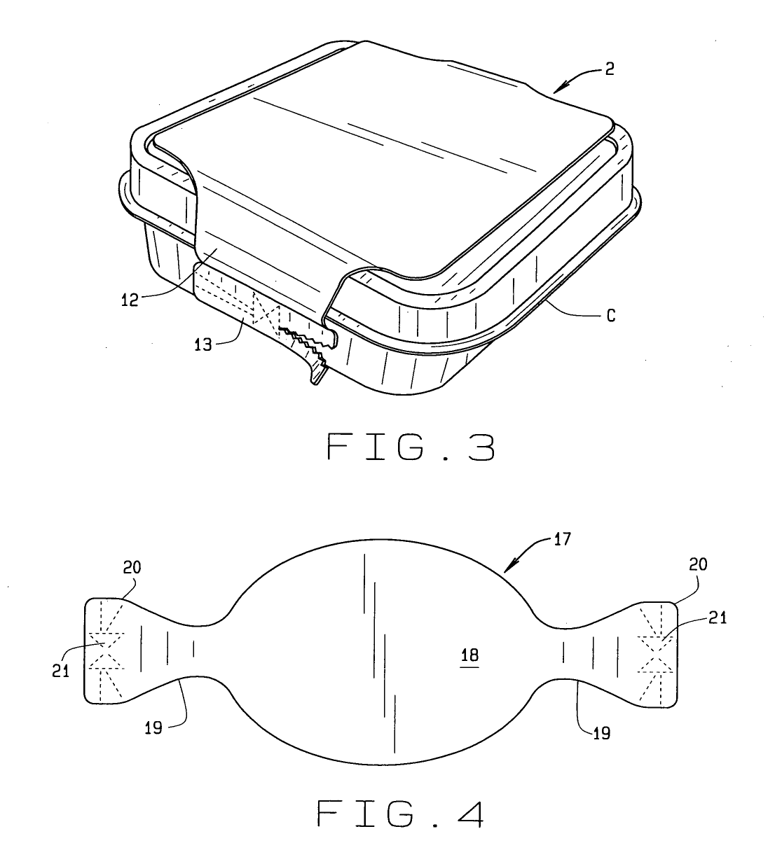

FIG. 2, need not remain in close contiguity with the container throughout their length. The ends of the label, as shown in FIG. 3, are shown adhered to the vertical sides and the horizontal bottom of the container. As can be seen and understood, the design of the label is such that a single label is suitable for use on a variety of container designs. The container in FIG. 2, for instance, has a symmetrical top surface, and the symmetrical label is easily adapted for use with the container, as can be seen in the illustration. A wrap label may also be fashioned specifically for use on a particular type or shape of container. As can be readily understood, the principal benefit of the label with its die-cut ends is to add significantly to the security of the contained goods, and to prevent unauthorized entry therein.

FIG. 3 provides a second perspective view from another angle of the wrap label 10 in use on the container of FIG. 2. It can be seen that the end portion of the label, as at 13, has been partially torn away, by one who has sought unauthorized access into the container. This is a warning to any prospective purchaser that the product should be turned into the store manager, and not purchased for consumption. A part of its die-cut lines have severed, which occurs when one attempts to enter into the container, through removal of its substantial label.

FIG. 4 shows a plan view for another label, of different appearance, as can be noted at 17. This label likewise has a substantial primary surface 18, and having integral legs 19 extending laterally from its surface. At the ends of the legs, as at 20, there are a series of die-cuts, as at 21, and which facilitate the destruction of the label, by tearing at the lines of the security cuts, when the primary surface of the wrap label 17 is attempted to be removed by an unauthorized person. Also, adhesive is applied to the undersurface of the ends 20 of the label, at the region of the lines of die-cuts, to allow the label to be applied to a container, after the container is filled and ladened with product for purchase. As summarized, the security die-cuts are incorporated at the point of attachment of the label to serve as a destructible agent so that any attempt to remove the tag from the product will cause it to tear or destruct at that point of attachment, giving evidence that the product has been tampered with. These die-cuts are really not designed to facilitate the removal of the intact label, but to function as a security means, to assure that no one has made an unauthorized tampering with attempts at removal of the label, and to present evidence of such. While the die-cuts are shown to some degree as being patterned, such die-cuts may be more randomly applied, so as to tear easily when one tampers with the ends of the label, in the manner as previously described with regard to the shown label in FIG. 3.

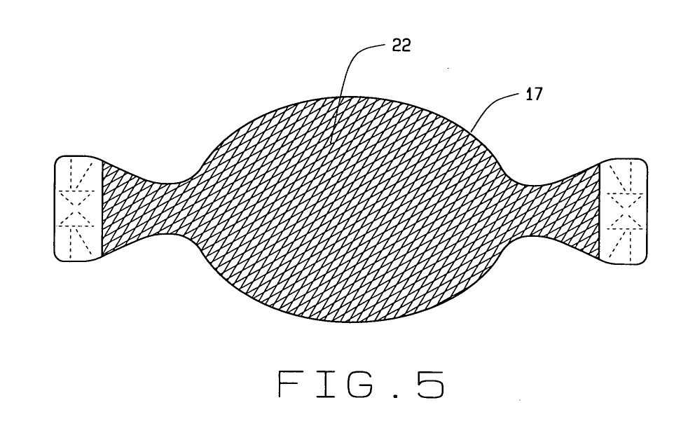

FIG. 5 shows a backside of the modified label disclosed in FIG. 4. The purpose here is to show how the label 17 on its backside, or that side intended to be contiguous with the upper surface of the container C may have applied thereto an adhesive deadening coating, as noted at 22, so that the label will not adhere to the container at this location, and allow this portion of the label to be used for other purposes, in the manner as previously described, to be subjected to printing on either of its both sides, at this location, or for use as a coupon, a warning label, description of contents, for bar code application, promotion, incentive, or for any other use as desired, such as the label having a peelable coupon applied to its upper surface, or even to its under surface, that may be removed for other usage, either before or after the removal of its label from the shown container C. Such adhesive deadening may be obtained from Actega-Radcare Co, under model No. 712V480, located at Wayne, N.J. Other adhesive deadening agents may also be used.

Variation or modifications to the subject matter of this invention may occur to those skilled in the art upon review of the summary of the invention as provided herein, and upon undertaking a study of the description of its preferred embodiment, in view of the drawings. Such variations, if within the spirit of this invention, are intended to be encompassed within the scope of any claims to patent protection obtained hereon. For example, the patterned label may be fabricated of paper, of a plastic, but which may likewise, due to their patterned perforation, be easily torn free from the ladened container.

I claim:

1. A security inherent wrap label for application to a container, comprising a patterned, die-cut piece of substantially planar flexible material, said label having a top and bottom surface, at least one primary surface for the application of indicia, coupons, and the like, and at least two ends provided for the label, with the patterned adhesive applied to the bottom surface of at least the ends for wrapping and adhering partially upon a container, said patterned die-cut provided within the ends, so that when unauthorized tampering of the label occurs, the patterned die-cut will sever, indicating that tampering of the wrap label has occurred.

2. The label of claim 1, wherein adhesive is applied to the ends of the label and to at least one other portion of the bottom surface of the label.

3. The label of claim 1, wherein the ends of the wrap label contain said series of die-cuts, within the region of the planer adhesive as applied to the bottom surface of the ends, and said lines of die-cuts tearing upon unauthorized tampering with the label, to indicate that one has previously attempted to tear open the label of the container.

4. The wrap label of claim 3 wherein said label is formed of paper.

5. The wrap label of claim 3 wherein said label is fabricated of polymer.

6. The wrap label of claim 3 wherein said label applies over the top of a container, and adhesively connects at its ends to one of the sides or bottom of the container.

7. The wrap label of claim 3 wherein the top of the wrap label is capable of adhering indicia thereon.

8. The wrap label of claim 3 wherein the top of the label is capable of adhering at least one coupon thereon.

9. The wrap label of claim 3 wherein the ends of the wrap label are substantially wider than the legs, to provide a greater expanse of surface area to which adhesive may be applied for adhering the label to the sides or bottom of the container to which the label is applied.

10. The wrap label of claim 9 wherein the lines of die-cuts are provided at the juncture between the label legs and their ends.
